(19) United States
(12) Patent Application Publication
(10) Pub. No.: US 2009/0024541 A1
(43) Pub. Date: Jan. 22, 2009

(54) POWER PURCHASE METHODS, AGREEMENTS AND FINANCIAL INSTRUMENTS FOR TAX-ADVANTAGED FINANCING RESIDENTIAL RENEWABLE ENERGY EQUIPMENT

(76) Inventor: Gary Kremen, San Diego, CA (US)

Correspondence Address: PERKINS COIE LLP, P.O. BOX 1208, SEATTLE, WA, 98111-1208, US

(21) Appl. No.: 11/781,127

(22) Filed: Jul. 20, 2007

(51) Int. Cl. G06Q 40/00

(52) U.S. Cl. 705/36 T

(57) ABSTRACT

A business method is disclosed for tax-advantaged financing renewable energy consumer premises equipment (CPE) for installation and operation on a residential premises of a residential consumer. The method comprises (a) agreeing to supply power generated by the renewable energy CPE to the residential premises of the residential consumer and (b) taking a real property security interest in a primary residence of the residential consumer, whereby the real property security interest secures payments for the power supplied to the residential consumer.

### BRIEF DESCRIPTION OF THE INVENTION

The present invention relates to power purchase methods, agreements and financial instruments for tax-advantaged financing of residential renewable energy equipment.

### BACKGROUND OF THE INVENTION

Electricity or power is an essential part of modern life. In residences, in businesses, in institutions and in other locations, consumers use electricity in a variety of ways. Utilities typically supply power to consumers as needed. FIG. 1 illustrates a diagram of a power system of the prior art. As is shown, the utilities deliver power generated by power plants through a network of transmission and distribution lines. This network is hereinafter referred to as the “power transmission and distribution grid,” “the electric grid,” “the grid” or “power grid.” Numerous publications describe electricity production, demand and costs in great detail. As will be appreciated by those skilled in the art, renewable energy is a practical and environmentally conscious alternative to traditional utility production. One of the more desirable renewable sources is solar power. For one thing, local solar energy can essentially be harnessed in most developed country locations with solar access. For another, solar equipment consumes no fossil fuels and generates no air pollutants. The use of solar power is generally regarded as environmentally safe. Utilities in many States are required (or voluntarily do so) for public policy reasons to credit or actually buy excess power generated by a consumer. Suffice it to say, solar energy is quite desirable and beneficial to a consumer. Unfortunately, solar power equipment is quite expensive for a consumer. While the U.S. Federal and State incentives are significant, the remaining costs for the purchase of solar equipment may be beyond the amount of cash a consumer has on hand or wishes to commit.

To date, there are limited financing options for the consumer or residential solar power equipment. These options are predominantly based on traditional financing products known as a mortgage, a secured loan in real property or deed of trust. Such products rely on a security interest in the consumer/borrowers real property. There are other financing options. Secured personal property loans (sometimes referred to as chattel mortgages or loans) and unsecured personal loans are also available for the purchase of solar equipment. Secured personal property loans are typically secured by the personal property. Secured personal property loans do not have tax deductibility for the interest component of any payments as the loan is not secured by the consumer's primary residence. Unsecured loans are not secured at all. Unsecured loans do not have tax deductibility for the interest component of any payments as the loan is not secured by the consumer's primary residence.

There is yet another financing option available for the consumer. It is known as a Power Purchase Agreement (“PPA”). There are several varieties of a PPA. One example of a PPA is offered by Citizenre Company (http://renu.citizenre.com) In a typical PPA arrangement, a party known as the PPA Investor purchases the solar equipment at the time of the installation for the consumer's residence. The PPA Investor or a third-party serving firm might maintain solar equipment on a consumers premises. The PPA Investor owns the equipment. In exchange for such equipment, the consumer agrees to purchase power generated by the solar equipment at a set pricing for a set or variable period. Payments may be the same every month, similar to a lease, or may fluctuate depending on the power production. In certain circumstances, a PPA may incorporate a lease. Depending on the arrangement, the lease might be a capital lease or operating lease. Also depending on the contact, the consumer might have the option of purchasing the equipment from the owner.

In a PPA, the PPA investor receives significant benefits from this arrangement. First, the PPA Investor will receive certain rebates and credits offered by U.S. States and Federal government (e.g., performance based incentive offered in California for certain solar sized systems). Second, the PPA Investor will receive tax credits (sometimes called the Investment Tax Credit) in an amount (currently 30%) of the gross investment in the equipment. Third, the PPA Investor may take U.S. federal tax deductions over a 5 year period of time for the accelerated depreciation of the solar equipment. In addition to these benefits, if financing is obtained for solar equipment, the PPA Investor may deduct the interest portion of the periodic payments under U.S. tax law to repay any financing obtained in conjunction with the purchase of the equipment. In short, the PPA Investor receives significant tax benefits and other benefits from the PPA arrangement. The consumer also receives certain benefits from a PPA arrangement. The consumer makes a modest or no up-front investment (might need a down payment), need not make any repairs to the renewable energy equipment (might be responsible depending on how things are structured) and need not wait for any rebates. In addition, the consumer actually locks in the set prices for future power consumption. However, for certain customers such as residential real property owners (individual tax payers), tax advantages (Investment Tax Credit, Accelerated Deprecation, Interest Deductions) are not available for any payments pursuant to a PPA arrangement. This is a significant disadvantage for the consumer under a PPA arrangement.

In certain other existing financing arrangements, however, tax deductions are available to parties in such leasing arrangements. In automobile financing, an entity may deduct any interest paid as part of finance payments when the arrangement involves a security interest or lien on the real property of the entity leasing the automobile. Los Angeles Firemen's Credit Union is one example of a company that offers such financing options. See www.lafirecu.org. In a typical arrangement, an entity finances (receives a loan) an automobile or other vehicle from a financing entity, and in return, the financing entity will hold a lien against the automobile as well as real property of the entity receiving financing (for primary residences only). Consequently, the automobile owner may deduct the interest portion of the payments to the financing entity.

Unfortunately, there does not exist any available tax deduction for the interest paid by the consumer for leasing consumer premises equipment under a PPA.

### SUMMARY OF THE INVENTION

In accordance with an embodiment of the present invention, a business method is disclosed for tax-advantaged financing renewable energy consumer premises equipment (CPE) for installation and operation on a residential premises of a residential consumer. The method comprises (a) agreeing to supply power generated by the renewable energy CPE to the residential premises of the residential consumer and (b) taking a real property security interest in a primary residence of the residential consumer, whereby the real property security interest secures payments for the power supplied to the residential consumer.

In accordance with an embodiment of the present invention, a business method is disclosed for financing renewable energy consumer premises equipment (CPE) by a consumer for power generation at a consumer premises. The business method comprises creating an agreement wherein (1) a residential consumer agrees to purchase power generated by the renewable energy from the entity and (2) the residential consumer grants the entity a real property security interest in a primary residence of the residential consumer.

In accordance with an embodiment of the present invention, an agreement is disclosed financing renewable energy consumer premises equipment (CPE) by a residential consumer for power generation at a residential consumer premises. The agreement comprises a provision wherein the residential consumer agrees to purchase power from the entity, the power being generated by the renewable energy CPE operating on the residential consumer's premises, and a provision wherein the residential consumer grants the entity a right to take a real property security interest in a primary residence of the residential consumer.

In accordance with an embodiment of the present invention, a business method is disclosed for financing renewable energy consumer premises equipment (CPE) for installation and operation on a consumer premises of a residential consumer. The method comprises creating an agreement wherein: (a) a PPA Investor agrees to install the renewable energy CPE on the consumer premises: (b) the PPA Investor agrees to provide power to the residential consumer for a period of time, the power being generated by the renewable energy CPE; (c) the residential consumer agrees to make periodic payments to the PPA Investor for the power during the period of time, wherein one or more payments includes an interest portion that is tax deductible to the residential consumer under U.S. law; and (d) the residential consumer grants the PPA Investor a right to take a real property security interest in a primary residence of the residential consumer to secure the payments.

In accordance with an embodiment of the present invention, a business method is disclosed for receiving financing for renewable energy consumer premises equipment (CPE) for installation and operation on a premises of a residential consumer. The method comprises (a) providing a real property security interest in a primary residence of the residential consumer to an entity; and (b) making payments to an entity for power generated by the renewable energy CPE on the residential consumers premises, wherein one or more payments includes an interest portion that is tax deductible to the residential consumer under U.S law.

In accordance with an embodiment of the present invention, a system is disclosed for receiving financing renewable energy consumer premises equipment (CPE) by a consumer for power generation at a consumer premises. The system comprises a renewable energy CPE owned by an entity; and an agreement between the consumer and the entity: (1) enabling an entity to install the CPE of the entity on the residential consumer premises; (2) requiring the consumer to purchase power from the entity that is generated by the CPE; and (3) granting the entity a real property security interest in the primary residence of the residential consumer.

In accordance with an embodiment of the present invention, a business method for financing renewable energy consumer premises equipment (CPE) by a consumer for power generation at a residential consumer premises. The method comprises creating a power purchase agreement (1) wherein a residential consumer agrees to purchase power generated by the renewable energy CPE from the entity, (2) wherein the residential consumer agrees to make payments to the entity for the power, and (3) wherein one or more payments comprises an interest portion.

In accordance with yet another embodiment of the present invention, a business method is disclosed for tax-advantaged financing renewable energy consumer premises equipment (CPE) for providing power to a residential premises of a residential consumer, the method comprising: (a) agreeing to supply power generated by the renewable energy CPE to the residential premises of the residential consumer; and (b) taking a real property security interest in real property of the residential consumer, whereby the real property security interest secures payments for the power supplied to the residential consumer.

### BRIEF DESCRIPTION OF THE DRAWINGS

The accompanying drawings, which are incorporated herein and constitute a part of the specification, illustrate embodiments of the invention, and together with the general description given above, the detailed description of the embodiments and the Appendix in this application, serve to explain the principals of the invention.

FIG. 1 illustrates a diagram of a prior art power system.

FIG. 2 illustrates a block diagram of a power system incorporating consumer premises equipment for a real property structure.

FIGS. 2A-B illustrates net and dual metering arrangements, respectively.

FIG. 3 illustrates a flow block diagram of a PPA relating to a PPA Investor.

FIG. 4 is a flow block diagram of a PPA relating to a customer.

### DETAILED DESCRIPTION OF THE INVENTION

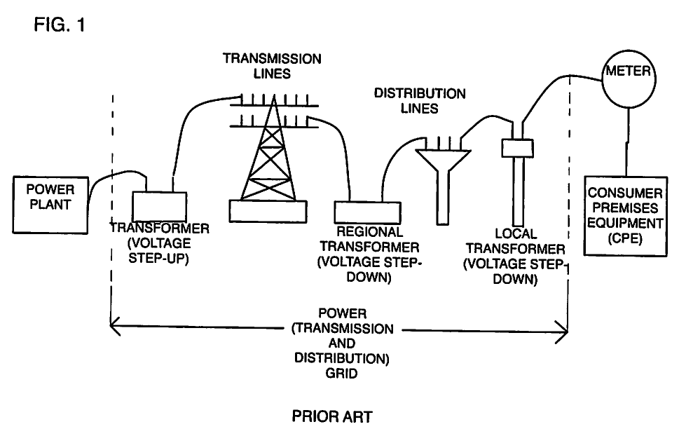

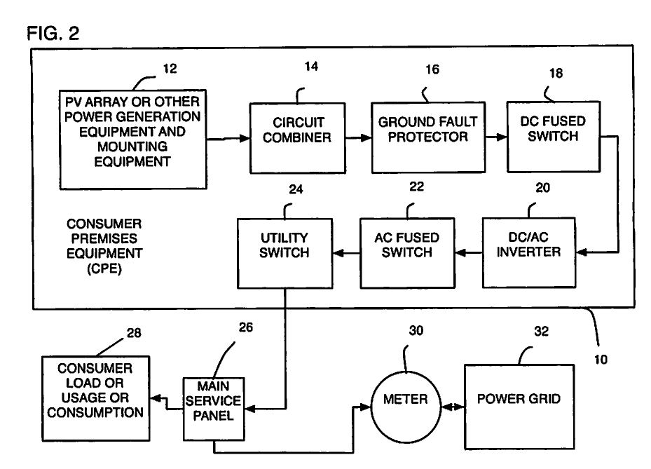

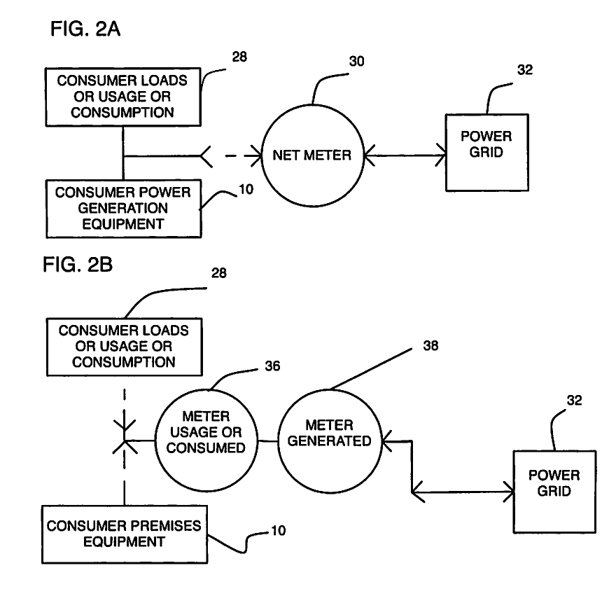

Prior Art FIG. 1 is described above. FIG. 2 illustrates consumer premises equipment 10 (also known or referred to as “CPE,” “consumer premises equipment,” “renewable energy consumer premises equipment” and “renewable energy CPE”) that resides on a residential building, but may alternatively reside on a business, institution or other real property. It is noted that many of the terms used in this application shall have the meaning set forth in the Appendix of this application unless defined differently directly herein. According to the embodiment of FIG. 2, CPE 10 incorporates renewable energy equipment that is used by the consumer for energy generation. In this embodiment, CPE 10 includes solar components such as the renewable energy equipment (source). Alternatively, any renewable equipment may be used such as wind, biomass or water (hydroelectric) energy generation equipment as well as non-renewable energy sources.

The solar components described herein are collectively known as photovoltaic (“PV” or “solar”) equipment (or system). In general, there are two types of PV systems: systems that interact with the utility power grid with no battery backup capability and systems that interact with the power grid and include battery backup. In addition, there are other systems that do not interact with the grid. In the embodiment shown in FIG. 2, the PV system (equipment) interacts with the power grid 32 but does not include a battery backup. As a result, this system operates only when the utility is available. This PV system will typically provide the greatest amount of savings to a consumer per dollar of investment. However, the system will shut down during an outage, and will remain that way until utility power is restored. Note that the consumer is a homeowner or resident for this discussion (sometimes referred to as a residential consumer).

CPE 10 comprises several components including a PV (photovoltaic) array 12 along with the appropriate mounting equipment. PV array 12 is made up of PV modules, which are environmentally sealed collections of PV cells. These cells convert the sunlight into electricity. CPE 10 includes mounting and wiring systems used to integrate the solar modules into the electrical systems of a residence or alternatively a business, institution or other consumer.

CPE 10 includes (as part of the wiring system) PV array circuit combiner 14, ground fault protector 16, DC fused switch 18 and DC/AC inverter 20 connected in series. PV array circuit combiner 14 is connected to PV array 12. DC fused switch 18 is used as over-current protection for the solar (PV) modules. Ground fault protection 16 is a circuit breaker. Combiner 14 is used since PV array 12 (modules) requires fusing for each module source circuit. Some inverters alternatively include the fusing and combining function within the inverter housing. Inverter 20 is designed to take the DC power from PV array 12 and convert it into standard AC power used by devices that consumes standard AC power.

CPE 10 further includes AC fused switch 22 and utility switch 24 connected in series (and connected to DC/AC inverter 20). AC fused switch 22 is used as a power disconnect (i.e., as an over-current protective device (OCPD)). Utility switch 24 is used by the utility to switch off PV array 12. Most utilities require a visible-blade, lockable open switch or disconnect in the inverter's output circuit. The utility switch 24 is usually located within sight of the service-entrance meter for ease of locating by emergency response people. It should be noted that CPE 10 might include additional components or fewer components than described herein depending on power and installation requirements. In addition to the above shut off mechanisms (e.g., switches), power shut off may be accomplished by disconnecting the leads of the power grid from the CPE and capping such leads to ensure the safety of those near the power leads.

The components of CPE 10 are connected to original components including main service panel 26, consumer loads or usage (or consumption) 28, meter 30 and a local segment of the utility power grid 32. Specifically, utility switch 24 is fused and is connected to main service panel 26. The maintenance service panel 26 includes among other things the residential circuit breakers. Main panel 26 is coupled to the residential wiring and loads 28.

Meter 30 is coupled between power grid 32 and main service panel 26. Meter 30 is a device for measuring electricity consumption. In this instance, meter 30 is capable of net metering (or other alternative metering schemes discussed below). This is shown in FIG. 2A. CPE 10 is shown interconnected to power grid 32 to enable the consumer to feed any surplus or excess power (electricity) to grid 32. Meter 30 will spin forward when power (electricity) flows from power grid 32 into the residence and backward when CPE 10 (solar components) produces surplus electricity that is not immediately used. (For purposes of this application, power consumed will have a negative value and power generated will have a positive value. This convention, however, may be switched.) Excess power (electricity) is “loaded” on power grid 32.

Utilities may require an agreement for consumers to qualify for net-metering. This is known as net metering to those skilled in the state of the art. In certain embodiments, there might be two separate meters as shown in FIG. 2B. In FIG. 2B, meter 36 and meter 38 are shown in series. Meter 36 is used as a measuring device for power consumed or used and meter 38 is used as a measuring device for power generated by the consumer's CPE. This “dual metering” convention may be desired by a consumer or required by a utility. This is because in some cases, the residential consumer's purchase price of power is different than the rate the utilities buy the power from the consumer.

The solar components or equipment of CPE 10 that is subject to or may be borrowed against (i.e., may be secured as collateral for borrowing purposes) includes PV array 12, circuit combiner 14, ground fault protector 16, DC switch 18, DC/AC converter 20 and possibly other components including the mounting equipment. Note that these components may be considered fixtures depending on implementation and local laws.

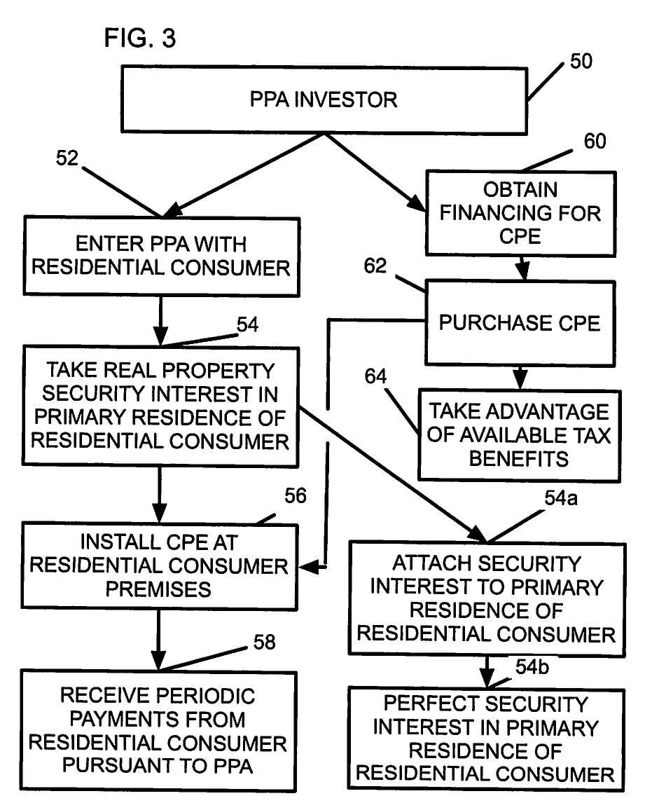

Reference is made to FIG. 3 wherein a flow diagram is shown illustrating the process undertaken by a PPA Investor. PPA Investor is identified by reference numeral (block) 50. PPA Investor 50 enters a PPA with the consumer at block 52. The PPA investor 50 may enter the PPA individually or through any suitable business entity. For example, the PPA may enter the PPA via a pass or flow through entity to gain liability protection and pass through tax benefits. As indicated above, the PPA includes terms in which the consumer purchases from the PPA investor (power generated by the CPE). Specifically, the consumer agrees to purchase power at a specified rate for a specified term. The rate may be based on consumer credit information or power production or utility prices or others factors including an index rate. The term of the PPA may be any duration. In an embodiment of the present invention, the PPA is structured such that one or more residential consumer payments include an interest portion and a principal portion. The early payments preferably consist entirely or almost entirely of interest. The interest may be explicitly stated in the PPA or imputed interest under the PPA. In the embodiment described herein, a PPA arrangement with interest and principal portions may be created in several ways including a lease, loan or some variable of each. For example, a PPA Investor of a PPA arrangement may loan a consumer $30 K for the CPE over a specified term (e.g., 7 years). Early monthly payments will consist entirely of interest, and at the conclusion of the term, the consumer will have the option to purchase the CPE (or be forgiven for the remainder of the loan). This is one example. Other lease and/or loan arrangements may be used to create a PPA with payments consisting of interest and principal portions. As discussed in more detail below, the residential consumer may take tax deductions for the interest portion of the payments under U.S law (“U.S law” means U.S. Federal and/or U.S. State law)

The PPA will also incorporate a provision granting PPA Investor 50 the right to take a real property security interest (also known as a lien), or an actual security interest, in the primary residence of the residential consumer to secure the payments under the PPA. A primary residence is generally a dwelling where one actually lives and is considered as the legal residence for U.S. income tax purposes. A real property security interest in primary residence of a residential consumer will enable the residential consumer to take a tax deduction for any interest portion of the payments to the PPA Investor for power generated by the CPE in accordance with U.S. tax code (Internal Revenue Service code or “IRS” code). The IRS code ultimately dictates the rules and limitations for automatic and non-automatic (traced) allowable deductions associated with multiple residential liens (e.g. mortgages). The primary residence of the residential consumer may be part of or the entire consumer premises upon which CPE 10 is disposed, or the primary residence may be another property unrelated to CPE 10. (The PPA will also require the consumer execute all necessary documents to attach and perfect the security interest in the real property of the consumer.) The PPA may incorporate other terms involving termination, CPE 10 maintenance and other terms of power purchasing (and possibly leasing). For purposes of this application, the term “provision” shall mean any portion, text, section or language of a written (e.g., paper or electronic) agreement between a consumer and a PPA Investor for financing CPE. When discussing a provision of the written agreement between the PPA Investor and consumer herein, the provision may be in the body of the written agreement, or alternatively, it may be set forth in an attachment to the agreement. In this respect, the agreement shall incorporate the attachment by reference therein.

At block 54, PPA Investor 50 shall actually take a security interest in the real property of the consumer in accordance with the PPA. As part of this process, PPA Investor 50 will attach a security interest in the real property of the consumer at subblock 54a and perfect the security interest (financial instrument) in the real property at subblock 54b. Attachment for real property shall be accomplished conventionally via a financial instrument (other than the PPA) such as a mortgage or other lien document evidencing the security interest. Perfection shall also be accomplished conventionally by recording the security interest (financial instrument) within the required governmental office. In most states, the location of filing is the county recorder's office in which the real property is located. (In most circumstances, the PPA Investor's security interest will be subordinate (second) to a first or primary mortgage with respect to the real property (primary residence). Therefore, a deed will not transfer to the PPA Investor upon execution of the real property security interest documents.) The recorded documents will remain of record until the PPA Investor is paid the full amount under the power purchase agreement. There is no further action needed on the part of the PPA Investor unless the residential consumer fails to pay (defaults on its obligation). Real property security interests including the rules regarding proper attachment and perfection (and rules pertaining to multiple mortgages/liens on real property) are determined by State law. The PPA may also include other security interests that comply with State law.

Following block 54, PPA Investor 50 shall install CPE 10 on the consumers premises at step 56. PPA Investor 50 shall likely perform periodic maintenance checks in accordance with the PPA. CPE 10 will preferably be coupled to the power grid 32 with or without a battery. However, CPE 10 need not be connected to power grid 32. Once CPE 10 is operational, PPA Investor 50 will receive payments from the consumer periodically over the term of the PPA. In the event PPA Investor 50 decides to obtain financing from a third party for obtaining CPE 10 (for the consumer's use), such financing may occur simultaneously with execution of the PPA or any other time provided that PPA Investor 50 purchases CPE 10 in sufficient time for timely installation at the consumers premises after PPA execution. Such financing and subsequent CPE 10 purchase is shown in blocks 60 and 62. The CPE purchased is thus installed at the consumer's premises. This is shown in dotted lines. Alternatively, PPA Investor may have sufficient equipment already on hand for the consumers installation. Lastly, PPA Investor may avail itself of the tax benefits associated with the financing discussed above such as the deductions for the interest portion of the loan payments. This is shown in block 64.

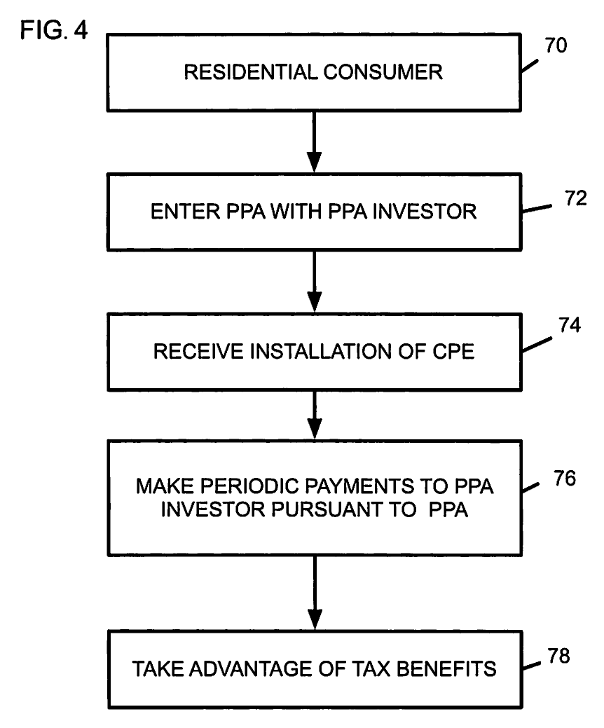

Reference is made to FIG. 4 wherein a flow block diagram is shown with respect to a consumer and a PPA. The consumer is identified by block 70 in FIG. 4. At block 72, consumer 70 enters a PPA with a PPA Investor 50. The PPA will include many provisions relating to the lease, power purchase, real property (and possibly other security interests), termination, PPA term and other provisions as discussed above. At block 74, consumer 70 receives the installation of CPE 10 at the consumer's premises. As indicated above, CPE 10 is coupled to power grid 32. However, there are alternative coupling options including the use of a battery. Once CPE 10 becomes operational, consumer 70 shall make periodic payments to PPA Investor 50 pursuant to the terms of the PPA at block 76. The periodic payment may be monthly or any other time frame under the PPA. At block 78, consumer 70 may take advantage of the tax benefits associated with the payments to PPA Investor 50. That is, consumer 70 may take tax deductions for any interest component that is part of the payments to PPA Investor 50 pursuant to applicable U.S. (IRS) tax statute or provision.

The foregoing description of the embodiments of the invention has been presented for purposes of illustration and description. It is not intended to be exhaustive or to limit the invention to the precise form disclosed and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and their equivalents.

### Appendix

### Terms and Definitions

“chattel mortgage” shall mean a loan to buy some personal item or good, the item or good being used as security for the loan.

“collateral” shall mean any property or asset pledged by a borrower to secure a loan or other credit, and subject it to seizure in the event of default. Collateral shall include any real or personal property including, without limitation, receivables.

“computer implementation” shall mean the execution of any or all process steps by computer.

“consumer” shall mean a user or purchaser of power (electricity).

“consumer premises” shall mean the premises of a consumer.

“consumer premises equipment” (also known or referred to as “CPE,” “renewable energy consumer premises equipment,” and “renewable energy CPE”) shall mean the physical assets of the CPE such as any and all renewable energy equipment that resides or is disposed on or near real property of the consumer. CPE also includes any and all mounting equipment. CPE may also be referred to as Consumer Power Equipment or Consumer Premises Owned Equipment.

“consumer credit information” shall mean any information relating to the credit granted to a consumer permitting the use or ownership of goods or services during a term of payment. Consumer credit information may also include information based on the character of the entity receiving financing (e.g., borrower), the cash flow of the entity receiving financing and the collateral pledged (if any) by the entity receiving financing. Credit information may a consumer's FICO score.

“credits” shall mean any money or other valuable consideration offered to an entity for certain defined acts.

“deed of trust” shall mean a document which pledges real property to secure a loan by a consumer. The property is deeded by a title holder (trustor) to a trustee (often a title or escrow company), which holds the title in trust for the beneficiary (the lender of the money). When the loan is fully paid, the trustor requests the trustee to return the title by reconveyance. If the loan becomes delinquent or is in default, the beneficiary can file a notice of default and, if the loan is not brought current, the trustee can demand that the trustee begin foreclosure on the property so that the beneficiary may either be paid or obtain title.

“default” shall mean the failure to make a payment when due, which can lead to a notice of default and the start of foreclosure proceedings if the debt is secured by real or personal property.

“dual metering” shall mean the use of two power measuring meters, one meter being used for measuring power consumption by the consumer and the other being used for measuring power generation by the CPE.

“entity” shall mean any person, group of persons, company, division, agency, partnership or other entity (private or government). Entity includes, without limitation, a PPA Investor.

“excess power” shall mean the power generated by the CPE that exceeds the power consumed by the consumer. Excess power is also referred to as “net power.”

“federal tax credits” shall mean any credits offered by a Federal entity to a consumer to offset any income tax due.

“FICO score” (Fair Isaac Company score) shall mean the mathematical model that is used as a tool by lenders to evaluate the risk associated with lending to an entity money.

“financial instrument” shall mean any real or virtual document representing a legal agreement involving some sort of monetary value. Such financial instrument can be classified as equity based, representing ownership of the asset, or debt based, representing a loan made by an investor to the owner of the asset. Financial instruments shall include “notes.” Financial instruments are also known as securities.

“interest” shall mean the fee that is charged by a financing entity (e.g., lender or PPA investor) to a borrower for the use of borrowed money, usually expressed as an annual percentage of the principal.

“imputed interest” shall mean the interest component of a payment which is not explicitly stated in an agreement between a lender and a borrower but implied under the agreement. The actual ratio of principal component vs. interest component can be set by formula, law or custom.

“loan” shall mean an arrangement in which a lender gives money to a borrower (the consumer), and the borrower agrees to return the property or repay the money, usually along with interest, at some future point(s) in time. Generally the lender has to bear the risk that the borrower may not repay a loan. A loan is evidenced by a specific financial instrument (or financial instruments).

“lease” shall mean an agreement granting use or occupation of personal or real property during a specified time for a specified payment.

“mortgage” shall mean a debt financial instrument by which the borrower (mortgagor or consumer) gives the lender (mortgagee) a lien on property as security for the repayment of a loan.

“net metering” shall mean a mechanism that is used as a utility resource usage and payment scheme in which a consumer who generates their own power is compensated monetarily for the excess of the power generated by the CPE over the power used by the consumer.

“note” shall mean a financial instrument or debt security that matures on a date set forth in the note. A loan might consist of or be supported by one or more notes.

“perfecting” is a means by which a lender establishes superior rights in collateral against any third parties.

“personal property” shall mean property of any kind except real property. Personal property may be tangible, having physical existence, or intangible, having no physical existence, such as financial instruments.

“power” (also known or referred to as “electricity” or “energy”) shall mean energy supplied to or used by a home, building or community.

“power grid” (also known as the “power transmission and distribution grid,” “electric grid” or “grid”) shall mean the network of transmission and distribution lines (and the step-up and step-down transformers) that is used to deliver electricity to consumers.

“power purchase agreement” shall mean an agreement between a power provider (e.g., PPA Investor) and a consumer in which the consumer agrees to purchase power from the power provider. The power may for example be power generated by the CPE installed on the consumer's premises.

“power usage or power consumed” shall mean power used or consumed over a period of time. Its units are Kilowatt-hours.

“PPA Investor” shall mean a power provider under an power purchase agreement that supplies power to a consumer that is generated by CPE on the consumer's premises.

“principal” shall mean the amount of a debt on which interest is calculated.

“primary residence” shall mean a dwelling where one actually lives and is considered as the legal residence for U.S. income tax purposes.

“real property” shall mean the land as well as any permanent fixtures on it including buildings, trees and other fixtures.

“real property security interest” shall mean a security interest in real property, including without limitation, consumer premises.

“rebates” shall mean a deduction from the amount due or a return of part of an amount given in payment.

“renewable energy” shall mean power supplied by energy sources that are naturally and continually replenished such as wind, solar power, geothermal, hydropower, and various forms of biomass.

“renewable energy source” shall mean sources of renewable energy such as water (hydroelectric power), wind, biomass and solar energy.

“residential consumer” shall mean consumer that is a homeowner or a resident.

“residential consumer premises” shall means a residential premises of a residential consumer.

“securities” shall mean financial instruments.

“security interest” shall mean any interest in a property that secures the payment of an obligation. The property subject to a security interest is often times called collateral. Security interests shall include attaching the security interest in the collateral and perfecting the security interest.

“utility” shall mean any entity that purchases, sells or markets power to (or from) the consumer of power or has the primary relationship with that consumer.

I claim:

1. A business method for tax-advantaged financing renewable energy consumer premises equipment (CPE) for installation and operation on or adjacent to a residential premises of a residential consumer, the method comprising:
(a) agreeing to supply power generated by the renewable energy CPE to the residential premises of the residential consumer; and
(b) taking a real property security interest in a primary residence of the residential consumer, whereby the real property security interest secures payments for the power supplied to the residential consumer.

2. The business method of claim 1 wherein agreeing is part of an agreement between an investor and a residential consumer.

3. The business method of claim 1 wherein agreeing includes agreeing to supply the power for a period of time.

4. The business method of claim 1 wherein agreeing includes agreeing to supply the power for a period of time at a flat rate or a rate based on an index.

5. The business method of claim 1 wherein the residential consumer premises includes the primary residence of the residential consumer.

6. The business method of claim 1 further comprising leasing the renewable energy CPE to the residential consumer for the period of time, prior to agreeing to supply power.

7. The business method of claim 1 further comprising purchasing the renewable energy CPE.

8. The business method of claim 7 further comprising obtaining a loan for purchasing the renewable energy CPE.

9. The business method of claim 8 further comprising making incremental payments to repay the loan.

10. The business method of claim 9 further comprising taking a U.S. Federal and/or State tax deduction for the portion of each payment that represents interest.

11. The business method of claim 1 wherein the interest is imputed interest under the agreement.

12. The business method of claim 1 wherein the interest is explicit interest under the agreement.

13. The business method of claim 8 further comprising taking a tax deduction for the depreciation of the renewable energy CPE.

14. The business method of claim 8 further comprising receiving a tax credit for the purchase of the CPE.

15. The business method of claim 14 wherein receiving a tax credit includes calculating a percentage of a gross price of the CPE as the tax credit.

16. The business method of claim 15 wherein the percentage is approximately 30%.

17. The business method of claim 1 wherein the agreeing to supply power and taking a real property security interest is performed by a PPA investor.

18. The business method of claim 8 further comprising carrying over loss of the life of the loan.

19. The business method of claim 1 further comprising making payments by the residential consumer for power generated by the renewable energy CPE.

20. The business method of claim 19 further comprising taking a tax deduction by the consumer for a portion of the payments that represent interest.

21. The business method of claim 1 further comprising receiving payments from the residential consumer for power generated by the CPE.

22. The business method of claim 1 wherein taking the real property security interest includes attaching the renewable energy CPE and perfecting the security interest in the renewable energy CPE.

23. A business method for financing renewable energy consumer premises equipment (CPE) by a consumer for power generation at a consumer premises, the method comprising:
creating an agreement wherein (1) a residential consumer agrees to purchase power generated by the renewable energy from the entity and (2) the residential consumer agrees to grant the entity a real property security interest in a primary residence of the residential consumer.

24. The business method of claim 23 wherein creating the agreement includes creating a provision in which the residential consumer agrees to make payments to the entity periodically for a period of time at a set rate for the power.

25. The business method of claim 24 wherein one or more of the payments includes an interest portion that is tax deductible under U.S. law to the residential consumer.

26. The business method of claim 25 wherein the interest is imputed interest under the agreement.

27. The business method of claim 25 wherein the interest is explicit interest under the agreement.

28. The business method of claim 23 wherein creating the agreement includes creating a financial instrument.

29. The business method of claim 23 wherein creating the agreement includes creating a provision in which the entity leases the renewable energy CPE to the consumer.

30. The business method of claim 23 wherein the consumer premises includes the primary residence of the residential consumer.

31. The business method of claim 23 further comprising obtaining a loan for purchasing the CPE by the entity.

32. The business method of claim 31 further comprising making incremental payments by the entity to repay the loan.

33. The business method of claim 32 further comprising taking a tax deduction for any portion of each payment that represents interest.

34. The business method of claim 31 further comprising taking a tax deduction for the depreciation of the renewable energy CPE.

35. The business method of claim 31 further comprising receiving a tax credit for the purchase of the CPE.

36. The business method of claim 35 wherein receiving a tax credit includes calculating a percentage of a gross price of the CPE as the tax credit.

37. The business method of claim 36 wherein the percentage is approximately 30%.

38. The business method of claim 23 wherein the entity is a PPA investor.

39. The business method of claim 23 further comprising making payments by the residential consumer to the entity for the power generated by the renewable energy CPE.

40. The business method of claim 23 further comprising taking a tax deduction by the residential consumer for a portion of the payments that represent interest.

41. The business method of claim 40 further comprising creating a flow through entity by the PPA investor for tax purposes.

42. An agreement financing renewable energy consumer premises equipment (CPE) by a residential consumer for power generation at a residential consumer premises, the agreement comprising:
a provision wherein the residential consumer agrees to purchase power from the entity, the power being generated by the renewable energy CPE operating on the residential consumer's premises; and
a provision wherein the residential consumer grants the entity a right to take a real property security interest in a primary residence of the residential consumer.

43. The agreement of claim 42 wherein the agreement is a financial instrument.

44. The agreement of claim 42 further comprising a provision wherein the residential consumer agrees to lease the renewable energy CPE from the entity.

45. The agreement of claim 42 further comprising a provision wherein the residential consumer agrees to make periodic payments to the entity for power generated by the renewable energy CPE.

46. The agreement of claim 42 wherein the real property security interest secures the payments for the power.

47. The agreement of claim 45 wherein one or more payments includes an interest portion.

48. The agreement of claim 47 wherein the interest portion of the payments are tax deductible under U.S. law.

49. The agreement of claim 43 wherein the entity is a PPA Investor.

50. The agreement of claim 43 further comprising a provision wherein the residential consumer agrees to purchase power for a period of time at a predetermined rate.

51. The agreement of claim 50 wherein the predetermined rate is fixed.

52. A business method for financing renewable energy consumer premises equipment (CPE) for installation and operation on a consumer premises of a residential consumer, the method comprising creating an agreement wherein:
(a) a PPA Investor agrees to install the renewable energy CPE on the consumer premises:
(b) the PPA Investor agrees to provide power to the residential consumer for a period of time, the power being generated by the renewable energy CPE;
(c) the residential consumer agrees to make periodic payments to the PPA Investor for the power during the period of time, wherein one or more payments includes an interest portion that is tax deductible to the residential consumer under U.S. law; and
(d) the residential consumer grants the PPA Investor a right to take a real property security interest in a primary residence of the residential consumer to secure the payments.

53. The business method of claim 52 wherein the agreement is a power purchase agreement.

54. The business method of claim 53 wherein the power is a set rate for purchase.

55. The business method of claim 52 wherein creating the agreement includes a provision wherein the PPA Investor leases the renewable energy CPE to the residential consumer.

56. A business method for receiving financing for renewable energy consumer premises equipment (CPE) for providing power to a premises of a residential consumer, the method comprising:
(a) providing a real property security interest in a primary residence of the residential consumer to an entity; and
(b) making payments to an entity for power generated by the renewable energy CPE on the residential consumer's premises, wherein one or more payments includes an interest portion that is tax deductible to the residential consumer under U.S law.

57. The business method of claim 50 further comprising leasing the renewable energy CPE to the residential consumer prior to making payments to the entity.

58. A system for receiving financing renewable energy consumer premises equipment (CPE) by a consumer for power generation at a consumer premises, the system comprising:
a renewable energy CPE owned by an entity; and
an agreement between the consumer and the entity:
(1) enabling an entity to install the CPE of the entity on the residential consumer premises;
(2) requiring the consumer to purchase power from the entity that is generated by the CPE; and
(3) granting the entity a real property security interest in the primary residence of the residential consumer.

59. A business method for financing renewable energy consumer premises equipment (CPE) by a consumer for power generation at a residential consumer premises, the method comprising:
creating a power purchase agreement (1) wherein a residential consumer agrees to purchase power generated by the renewable energy CPE from the entity, (2) wherein the residential consumer agrees to make payments to the entity for the power, and (3) wherein one or more payments comprises an interest portion.

60. The method of claim 53 wherein creating an agreement includes creating a provision wherein the consumer grants the entity the right to a real property security interest in the primary residence of the residential consumer.

61. A business method for tax-advantaged financing renewable energy consumer premises equipment (CPE) for providing power to a residential premises of a residential consumer, the method comprising:
(a) agreeing to supply power generated by the renewable energy CPE to the residential premises of the residential consumer; and
(b) taking a real property security interest in real property of the residential consumer, whereby the real property security interest secures payments for the power supplied to the residential consumer.
